(19) United States
(12) Patent Application Publication
(10) Pub. No.: US 2025/0241239 A1
(43) Pub. Date: Jul. 31, 2025

(54) Mowing Member of a Mowing Mechanism

(71) Applicant: CLAAS Saulgau GmbH, Bad Saulgau (DE)

(72) Inventors: Christian Speer, Aach (DE); Josef Fischer, Biberach (DE)

(21) Appl. No.: 19/039,232

(22) Filed: Jan. 28, 2025

(30) Foreign Application Priority Data
Jan. 29, 2024 (DE) 102024102487.9

(51) Int. Cl. A01D 34/73

(52) U.S. Cl. CPC A01D 34/733

(57) ABSTRACT

Mowing member (2a, 2b) of a mowing mechanism (1) of an agricultural harvesting machine, having a cutter disk (3), a cutter flange (6), a pressure disk (7) and at least one resilient element (8, 9), wherein the cutter flange (6) is arranged at a first side of the cutter disk (3), wherein the pressure disk (7) is arranged at a second side of the cutter disk (3), wherein the at least one resilient element (8, 9) presses the cutter flange (6) and the pressure disk (7) against each other and thus clamps the cutter disk (3) between the cutter flange (6) and the pressure disk (7), wherein, in order to exchange the cutter disk (3), the cutter flange (6) and the pressure disk 10 (7) can be pressed apart from each other counter to the resilient force of the at least one resilient element (8, 9). FIG. 4

DE 1 945 760 U discloses a mowing mechanism of an agricultural harvesting machine having a plurality of mowing members which are arranged beside each other in a row. The mowing members have cutter disks as cutting tools. The cutter disks have a plurality of cutting tips in a state distributed over the circumference thereof.

EP 3 942 919 A1 discloses a cutter disk for a mowing member of a mowing tool, which cutter disk again has a plurality of cutting tips in a state distributed over the circumference.

EP 3 143 865 B1 discloses a mowing mechanism having a plurality of mowing members which are arranged beside each other, wherein in this case the mowing members have a blade carrier, on which two blades are secured in a diametrically opposed manner. The blade carriers with the blades secured thereto do not form cutter disks.

The exchange of a defective cutter disk on a mowing member of a mowing mechanism is relatively complex until now. To this end, the mowing member has to be disassembled using tools in order finally to allow an exchange of the cutter disk.

There is a need for a mowing member having a cutter disk, in which the cutter disk can be easily exchanged with less complexity.

On this basis, an object of the present invention is to provide a novel mowing member of a mowing mechanism.

This object is achieved by a mowing member of a mowing mechanism according to claim 1.

The mowing member according to the invention has a cutter disk, a cutter flange, a pressure disk and at least one resilient element, wherein the cutter flange is arranged at a first side of the cutter disk and wherein the pressure disk is arranged at a second side of the cutter disk.

The at least one resilient element presses the cutter flange and the pressure disk against each other and thus clamps the cutter disk between the cutter flange and the pressure disk, and wherein, in order to exchange the cutter disk, the cutter flange and the pressure disk can be pressed apart from each other counter to the resilient force of the at least one resilient element.

In the mowing member according to the invention, the cutter disk is clamped between the cutter flange and the pressure disk, wherein, in order to exchange the cutter disk, this clamping action is canceled by the cutter flange and the pressure disk being pressed apart from each other counter to the resilient force of the at least one resilient element. The action of pressing apart is preferably carried out by means of a cutter disk exchange tool. The exchange of a cutter disk can be carried out with a small number of actions.

Preferably, the mowing member according to the invention further has a hooked disk and a pressure piece, wherein the hooked disk and the cutter flange are connected to each other, wherein the pressure piece and the pressure disk are connected to each other, and wherein a first resilient element on a portion which extends through a recess of the cutter disk is connected to the cutter flange and the hooked disk. A second resilient element can be arranged between the cutter flange and the pressure piece. This allows an advantageously simple and rapid exchange of a cutter disk on the mowing member. Preferably, the first resilient element and/or the second resilient element press(es) the pressure disk against the cutter flange. The clamping of the cutter disk between the cutter flange and the pressure disk is carried out via at least one of these resilient elements.

Preferably, the hooked disk extends with a hook through a recess in the pressure piece, wherein, when a cutter disk exchange tool engages with the hook, the cutter disk exchange tool is supported on the hooked disk and the pressure piece, and wherein, by actuating the cutter disk exchange tool, a relative movement between the hooked disk and the pressure piece and furthermore a relative movement between the cutter flange and the pressure disk can be provided.

Via the relative movement between the cutter flange and the pressure disk, the cutter flange and the pressure disk can be pressed apart from each other counter to the resilient force of the at least one resilient element in order to exchange the cutter disk. This allows a particularly advantageous, simple exchange of a cutter disk on the mowing member according to the invention.

Preferably, the cutter disk has radial projections, wherein the cutter flange also has radial projections, wherein in a first relative position between the cutter disk and the cutter flange the radial projections of the cutter flange cover the radial projections of the cutter disk, and wherein in a second relative position between the cutter disk and the cutter flange the radial projections of the cutter flange do not cover the radial projections of the cutter disk. In the first relative position, the cutter disk cannot be removed from the cutter flange. In the second relative position of the cutter disk, however, the cutter disk can be removed from the cutter flange.

Preferred further developments of the invention will be appreciated from the dependent claims and the following description. Exemplary embodiments of the invention are explained in greater detail with reference to the drawings without being limited thereto. In the drawings:

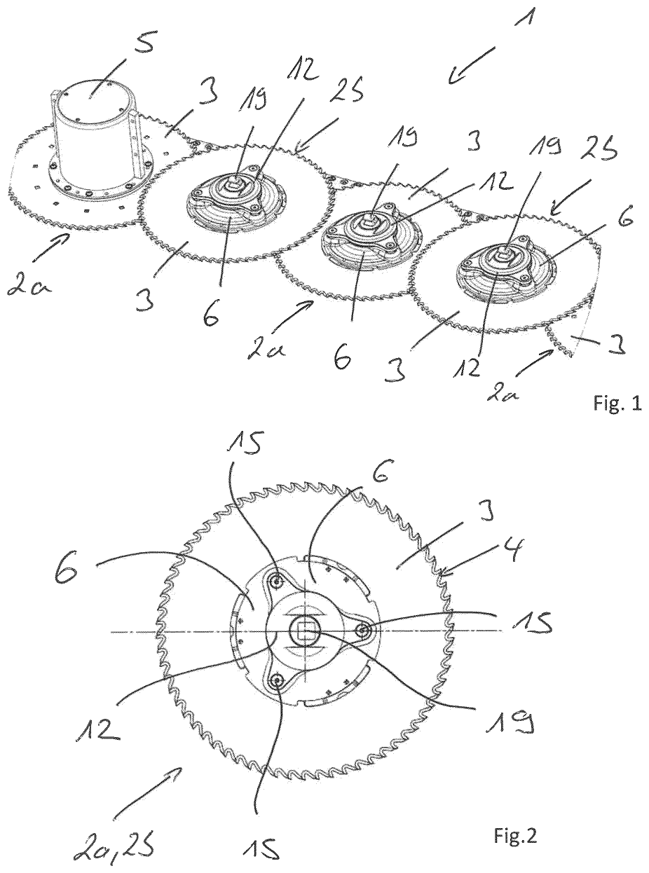

FIG. 1 shows a perspective view of a mowing mechanism with mowing members according to the invention;

FIG. 2 shows a plan view of a mowing member according to the invention;

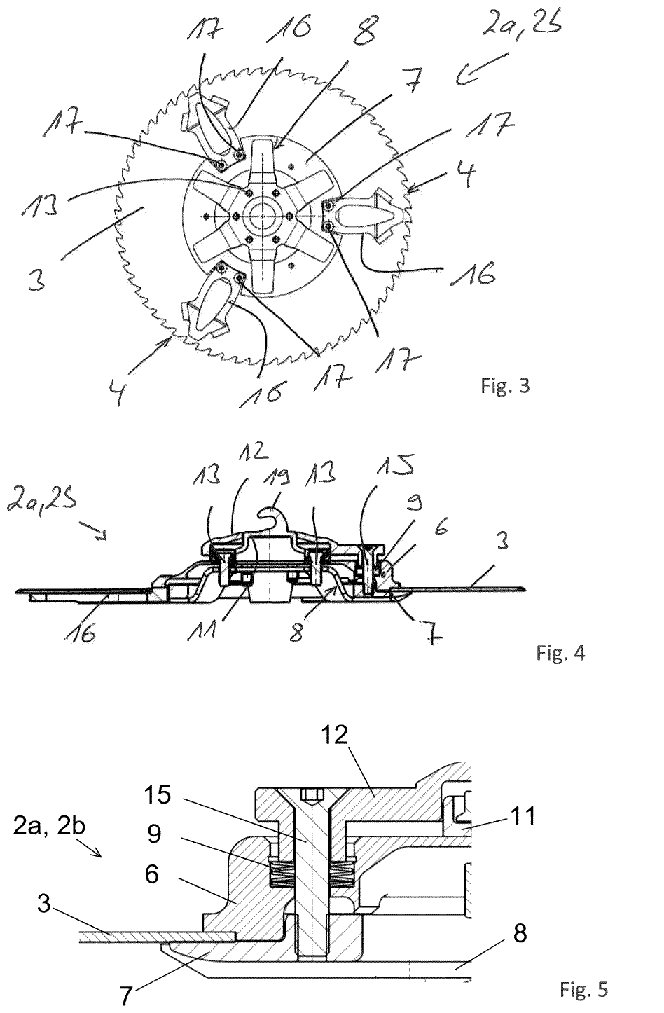

FIG. 3 shows a bottom view of a mowing member according to the invention;

FIG. 4 shows the cross section IV-IV of FIG. 2;

FIG. 5 shows a detail of a cross section similar to FIG. 4;

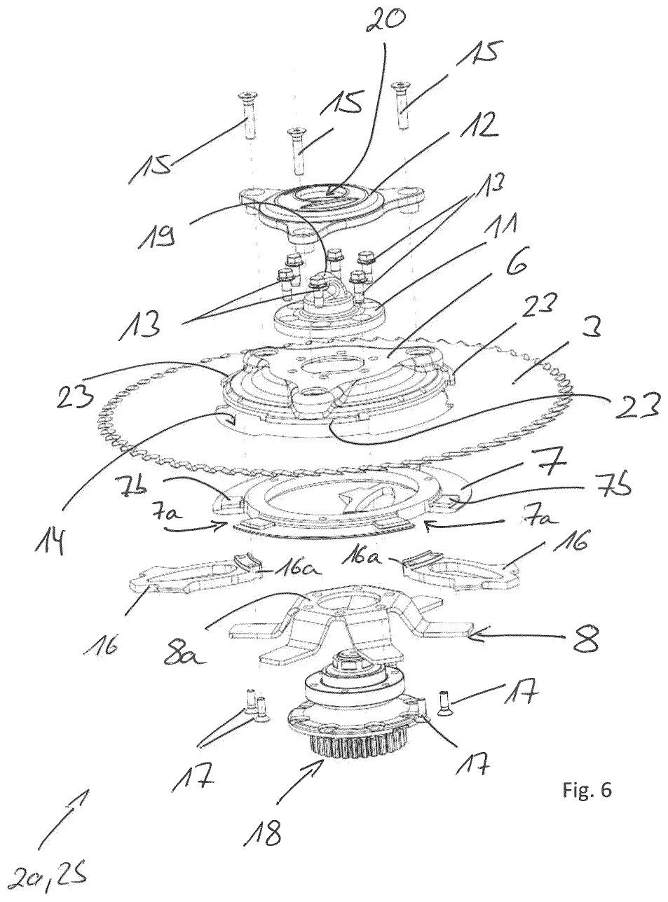

FIG. 6 shows an exploded illustration of a mowing member according to the invention;

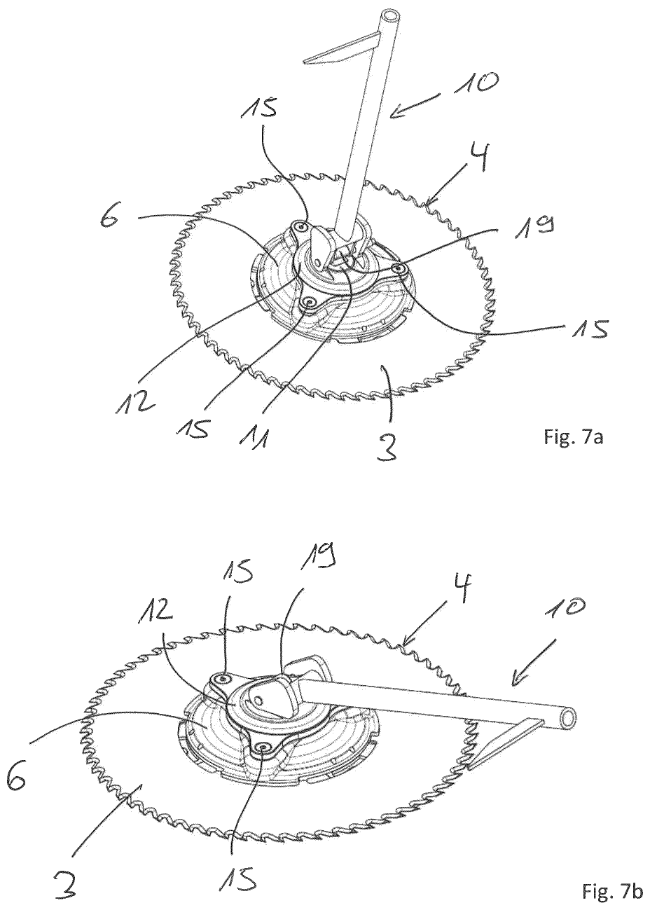

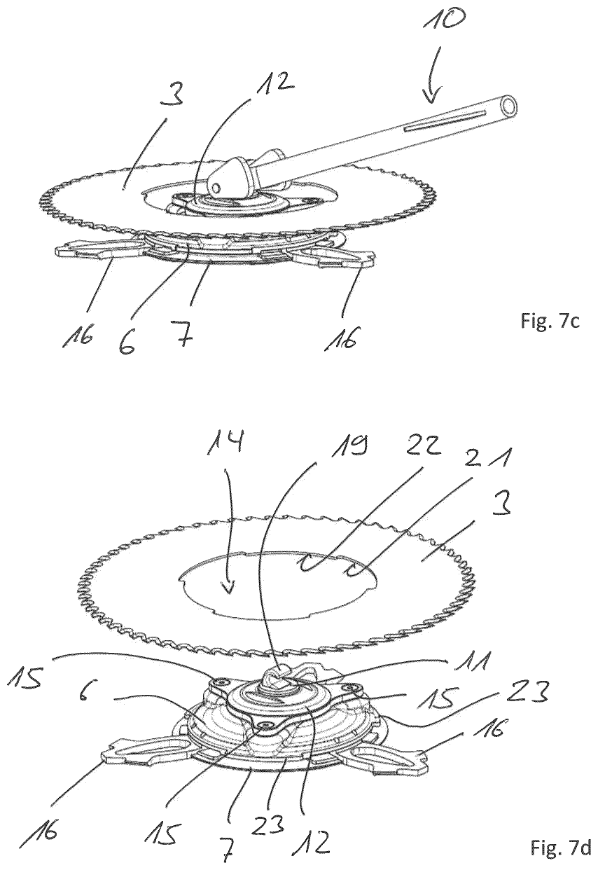

FIGS. 7a to 7d show a sequence during the change of a cutter disk on a mowing member according to the invention;

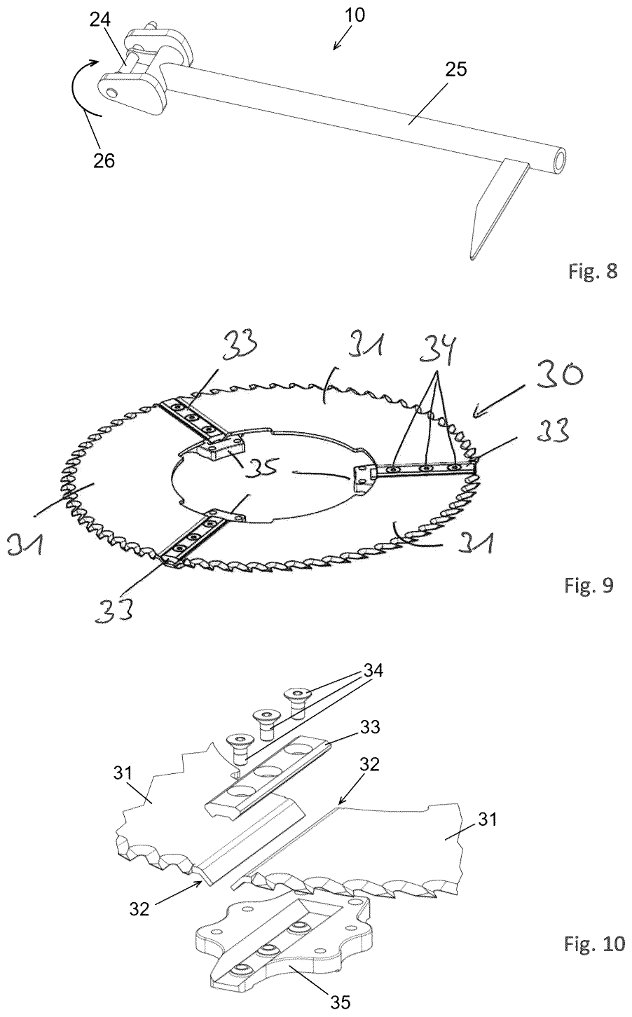

FIG. 8 shows a cutter disk exchange tool;

FIG. 9 shows a cutter disk of an additional mowing member of the mowing mechanism;

FIG. 10 shows a detail of FIG. 9.

FIG. 1 shows a cut-out of a mowing mechanism 1 in the region of a plurality of mowing members 2a, 2b. The mowing members 2a, 2b are positioned beside each other in a row so as to form a mowing bar.

The mowing members 2a, 2b have cutter disks 3. According to FIG. 1, the cutter disks 3 overlap with directly adjacent mowing members 2a, 2b in a projection, wherein the cutter disks 3 of the mowing members 2a are arranged in a first lower plane and the cutter disks 3 of the mowing members 2b are arranged in a second upper plane so that the overlapping mowing disks 3 of the directly adjacent mowing members 2a, 2b can rotate freely. The cutter disks 3 carry at the circumference thereof a plurality of cutting tips 4. A drive 5 is associated with the external mowing member 2a shown in FIG. 1. The drive 5 is used to drive all the mowing members 2a, 2b via a gear mechanism which is not shown.

FIGS. 2 to 5 show the structure of a mowing member 2a, 2b according to the invention, that is to say, in FIG. 1 a mowing member 2a, 2b, with which the drive 5 is not associated.

The mowing member 2a, 2b has, in addition to the cutter disk 3, a cutter flange 6 and a pressure disk 7. The cutter flange 6 is arranged at a first upper side of the cutter disk 3 (see FIG. 2), the pressure piece 7 is positioned at a second lower side of the cutter disk 3 (see FIG. 3). Furthermore, the mowing member 2a, 2b has at least one resilient element 8, 9, wherein the at least one resilient element 8, 9 presses the cutter flange 6 and the pressure disk 7 against each other and thus clamps the cutter disk 3 between the cutter flange 6 and the pressure disk 7. In order to exchange the cutter disk 3, the cutter flange 6 and the pressure disk 7 can be pressed apart from each other counter to the resilient force 5 of the at least one resilient element 8, 9, wherein to this end a cutter disk exchange tool 10 is used. FIG. 8 shows the cutter disk exchange tool 10 alone. FIGS. 7a to 7c show the same cutter disk exchange tool 10 when a cutter disk 3 is being exchanged.

In the preferred embodiment of the mowing member 2a, 2b according to 10 the invention, the mowing member 2a, 2b has, in addition to the cutter disk 3, the cutter flange 6 and the pressure piece 7 and the at least one resilient element 8, 9, a hooked disk 11 and a pressure piece 12. The hooked disk 11 and the pressure piece 12 are arranged together with the cutter flange 6 at the first upper side of the cutter disk 3. The pressure disk 7 is positioned at the opposite second side of the cutter disk 3. 15

The hooked disk 11 and the cutter flange 6 are connected to each other, preferably via the screws 13 which are shown in FIG. 6 and which additionally connect the first resilient element 8 to the cutter flange 6, that is, at a portion 8a of the first resilient element 8 which extends through a recess 14 in the cutter disk 3 20 and which, in the mounted state, is arranged at the first upper side of the cutter disk 3.

The pressure piece 12 is connected to the pressure disk 7 via the screws 15 which are shown in FIG. 6. In this case, the screws 15 extend through the cutter flange 6, and also through the second resilient elements 9 (see FIG. 5), 25 wherein the second resilient elements 9 are positioned between the cutter flange 6 and the pressure piece 12.

FIGS. 3, 6 further show broaching members 16 of the respective mowing member 2a, 2b. The broaching members 16 are mounted on the cutter carrier 6 via screws 17, wherein the radially inner portions 16a of the broaching members 16 which are secured to the cutter flange 6 via the screws 17 engage in recesses 7a in the pressure disk 7.

FIG. 6 further shows a drive gear 18 for the respective mowing member 2a, 2b in order to drive the cutter disk 3 of the mowing member 2a, 2b.

The first resilient element 8 presses the pressure disk 7 from below against the cutter flange 6. The second resilient element 9 presses the cutter flange 6 from above against the pressure disk 7. The cutter disk 3 is thereby clamped with a radially inner edge portion between the cutter flange 6 and the pressure disk 7. This further brings about a torque support.

The hooked disk 11 extends through the pressure piece 12 with a hook 19 through a recess 20 in the pressure piece 12.

At times when the cutter disk exchange tool 10 engages with the hook 19 in the context of FIGS. 7a, 7b and 7c, the cutter disk exchange tool 10 is supported, on the one hand, on the hooked disk 11 and, on the other hand, on the pressure piece 12. By means of a pivot movement of the cutter disk exchange tool 10 from the position shown in FIG. 7a into the position shown in FIGS. 7b, 7c, a relative movement between the hooked disk 11 and the pressure piece 12 is provided, and furthermore a relative movement between the cutter flange 6 and the pressure disk 7, in order to press the cutter flange 6 and the pressure disk 7 apart from each other counter to the resilient force of the at least one resilient element 8, 9, and thus to cancel the clamping action of the cutter disk 3 between the cutter flange 6 and the pressure disk 7.

As can best be seen in FIG. 7d, the cutter disk 3 has, at the radially inner edge thereof which delimits the recess 14, indentations 21 and radially inwardly extending radial projections 22. The cutter flange 6 also has radial projections 23. The projections 22 and indentations 21 bring about additional torque support.

In a first relative position between the cutter disk 3 and the cutter flange 6, the radial projections 23 of the cutter flange 6 cover the radial projections 22 of the cutter disk 3. In this case, the cutter disk 3 is then retained on the cutter flange 6 in a positive-locking manner so that the cutter disk 3 cannot be removed from the cutter flange 6.

By rotating the cutter disk 3 in the circumferential direction, the cutter disk 3 can be moved into a second relative position in relation to the cutter flange 6. In the second relative position between the cutter disk 3 and the cutter flange 6, the radial projections 23 of the cutter flange 6 do not cover the radial projections 22 of the cutter disk, but instead project into the indentations 21, wherein then in this second relative position the cutter disk 3 can be removed from the cutter flange 6 according to FIGS. 7c, 7d in order to exchange it for a new cutter disk 3.

The cutter disk exchange tool 10 has a bolt 24 which can be brought into engagement with the engaging hook 19 of the engaging disk 11. By pivoting the cutter disk exchange tool 10 by means of a handle 25 thereof, a pivot movement of the cutter disk exchange tool 10 is carried out about the bolt 24 in the direction of the arrow 26 in order to move the cutter disk exchange tool 10 from the state of FIG. 7a into the state of FIG. 7b and thus to cancel the clamping action of the cutter disk 3 between the cutter flange 6 and the pressure disk 7 and thus ultimately to allow an exchange thereof. The cutter disk exchange tool 10 engages in the end position thereof of FIGS. 7b, 7c and allows simple exchange of the cutter disk 3. Subsequently, the cutter disk exchange tool 10 can be released again.

As can best be seen in FIG. 6, the pressure disk 7 has axial projections 7b. At times when at least one resilient element 8, 9 brings about the clamping action of the cutter disk 3 between the cutter flange 6 and the pressure disk 7, these axial projections 7b of the pressure disk 7 engage in the indentations 21 of the cutter disk 3. The projections 7b bring about an additional torque support in the positive-locking connection with lateral edges of the indentations 21.

FIGS. 9, 10 show details of an alternative cutter disk 30 which can preferably be used in the field of external mowing members of a mowing mechanism 1, particularly in the field of the mowing member 2a, in the region of which the drive 5 is fitted. The cutter disk 30 of FIG. 9 is composed of three segments 31, wherein the segments 31 are connected to each other at mutually facing separation locations 32. This connection of the segments 31 at the mutually opposite separation locations 32 is carried out by means of a clamping piece 33 which is screwed to a broaching member 35 via screws 34 and which in this case clamps adjacent separation locations 32 of two mutually adjacent segments 31 of the mowing disk 30 between the clamping piece 33 and the broaching member 35. Thus, cutter disks 30 of the external mowing members can also be readily exchanged without any need for the drive 5 to be disassembled.

### LIST OF REFERENCE NUMERALS

1 Mowing mechanism
2a Mowing member
2b Mowing member
3 Cutter disk
4 Cutter tip
5 Drive
6 Cutter flange
7 Pressure disk
7a Recess
7b Projection
8 Resilient element
9 Resilient element
10 Cutter disk exchange tool
11 Hooked disk
12 Pressure piece
13 Screw
14 Recess
15 Screw
16 Broaching member
16a Portion
17 Screw
18 Drive gear
19 Hook
20 Recess
21 Indentation
22 Projection
23 Projection
24 Bolt
25 Handle
26 Pivot movement of cutter disk exchange tool
30 Cutter disk
31 Segment
32 Separation location
33 Clamping piece
34 Screw
35 Broaching member

In the claims:

1. A mowing member (2a, 2b) of a mowing mechanism (1) of an agricultural harvesting machine,
having a cutter disk (3), a cutter flange (6), a pressure disk (7) and at least one resilient element (8, 9),
wherein the cutter flange (6) is arranged at a first side of the cutter disk (3),
wherein the pressure disk (7) is arranged at a second side of the cutter disk (3),
wherein the at least one resilient element (8, 9) presses the cutter flange (6) and the pressure disk (7) against each other and thus clamps the cutter disk (3) between the cutter flange (6) and the pressure disk (7),
wherein, in order to exchange the cutter disk (3), the cutter flange (6) and the pressure disk (7) can be pressed apart from each other counter to the resilient force of the at least one resilient element (8, 9).

2. The mowing member according to claim 1, characterized by
a hooked disk (11) and a pressure piece (12),
wherein the hooked disk (11) and the cutter flange (6) are connected to each other,
wherein the pressure piece (12) and the pressure disk (7) are connected to each other,
wherein a first resilient element (8) on a portion which extends through a recess (14) of the cutter disk (3) is connected to the cutter flange (6) and the hooked disk (11).

3. The mowing member according to claim 2, characterized in that
the first resilient element (8) presses the pressure disk (7) against the cutter flange (6).

4. The mowing member according to claim 2, characterized in that
a second resilient element (9) is arranged between the cutter flange (7) and the pressure piece (12).

5. The mowing member according to claim 4, characterized in that
the second resilient element (9) presses the cutter flange (6) against the pressure disk (7).

6. The mowing member according to claim 2, characterized in that
the hooked disk (11), the cutter flange (6) and the pressure piece (12) are arranged at the first side of the cutter disk (3).

7. The mowing member according to claim 2, characterized in that
the hooked disk (11) extends with a hook (19) through a recess (20) in the pressure piece (12).

8. The mowing member according to claim 7, characterized in that,
when a cutter disk exchange tool (10) engages with the hook (19), the cutter disk exchange tool (10) is supported on the hooked disk (11) and the pressure piece (12),
by actuating the cutter disk exchange tool (10), a relative movement between the hooked disk (11) and the pressure piece (12) and furthermore a relative movement between the cutter flange (6) and the pressure disk (7) can be provided in order to press the cutter flange (6) and the pressure disk (7) apart from each other counter to the resilient force of the at least one resilient element (8, 9) in order to exchange the cutter disk (3).

9. The mowing member according to claim 1, characterized in that
the cutter disk (3) in the region of a recess (14) and the cutter flange (6) each have radial projections (22, 23),
in a first relative position between the cutter disk (3) and the cutter flange (6) the radial projections (23) of the cutter flange (6) cover the radial projections (22) of the cutter disk (3), in a second relative position between the cutter disk (3) and the cutter flange (6) the radial projections (23) of the cutter flange (6) do not cover the radial projections (22) of the cutter disk (3).

10. The mowing member according to claim 9, characterized in that
the pressure disk (7) has axial projections (7b),
in a first relative position and in a second relative position between the cutter disk (3) and the cutter flange (7) the axial projections (7b) of the pressure disk (7) engage in indentations (21), which are formed between the radial projections (22) of the cutter disk (3), of the cutter disk (3).
